(19) United States
(12) Patent Application Publication
(10) Pub. No.: US 2016/0275139 A1
(43) Pub. Date: Sep. 22, 2016

(54) DEVICE APPLICATIONS AND SETTINGS SEARCH FROM SERVER SIGNALS

(71) Applicant: Microsoft Technology Licensing, LLC, Redmond, WA (US)

(72) Inventors: Ashish Gandhe, Redmond, WA (US); MIchal Lewowski, Bellevue, WA (US); Jiantao Sun, Bellevue, WA (US); Thomas Lin, Bellevue, WA (US); Chenlei Guo, Seattle, WA (US); Vipul Agarwal, Bellevue, WA (US); Elbio Renato Torres Abib, Bellevue, WA (US)

(73) Assignee: Microsoft Technology Licensing, LLC, Redmond, WA (US)

(21) Appl. No.: 15/062,167

(22) Filed: Mar. 6, 2016

Related U.S. Application Data
(60) Provisional application No. 62/135,761, filed on Mar. 20, 2015.

(51) Int. Cl. G06F 17/30; G06N 99/00

(52) U.S. Cl. CPC G06F 17/30389; G06F 17/30864; G06N 99/005

(57) ABSTRACT

Architecture that utilizes server-based signals (e.g., past engagement, application popularity, spell-correction, mined search patterns, machine learning models, etc.) to improve relevance of search results for local applications and settings. The architecture works for any operating system (OS) and any client device that has local settings or applications installed. The architecture also covers instances where server-signals are being used to improve queries on devices where settings are searched but no applications are installed or will not be installed.

### CROSS-REFERENCE TO RELATED APPLICATIONS

This application claims the benefit of U.S. Provisional Patent Application Ser. No. 62/135,761 entitled “DEVICE APPLICATIONS AND SETTINGS SEARCH FROM SERVER SIGNALS” and filed Mar. 20, 2015, the entirety of which is incorporated by reference herein.

### BACKGROUND

Traditionally, search on device operating systems has been limited to a local indexer and search component to return the results for local content. Using a search box on the device returns only local results (e.g., files, applications, settings) while using the browser search returns web results. Search is considered such an important feature to users that demarcations between local device search and web search need to be overcome.

### SUMMARY

The following presents a simplified summary in order to provide a basic understanding of some novel implementations described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture utilizes server-based signals (e.g., past engagement, application popularity, spell-correction, mined search patterns, machine learning models, etc.) to improve relevance of search results of the local applications and settings. The architecture works for any operating system (OS) and any device that has local settings or has applications installed. This covers instances where server-signals are being used to improve queries on devices where settings are searched but no applications are installed or will not be installed.

The architecture can comprise a system, which includes a backend services component configured to receive a query from a frontend application of a frontend system as part of a user session, and enable access to a lookup table (LUT) to find relevant applications and settings of the frontend system. The backend services component returns the relevant applications and settings to the frontend application for presentation as search results. The system can also comprise a backend log component configured to receive a search log of the user session from the frontend system, store the search log, and enable access to the search log for use for log analysis and model training.

The architecture can also comprise a method, that comprises receiving a query at a backend system from a frontend application of a frontend system as part of a user session; accessing a lookup table in the backend system to find relevant applications and settings information of the frontend system; and returning the relevant applications and settings information from the backend system to the frontend application for presentation as search results.

The following techniques can be employed to retrieve relevant application and settings, given the user query. This can be accomplished by: mining past sessions of searches to retrieve patterns from unsuccessful sessions and understand eventually the user intent; using search engine techniques and infrastructure (e.g., speller, machine learning models, etc.) to obtain more likely candidates that are relevant for the query; solving the ranking problem of those candidates; and automatically improving the relevance of the technology to return applications and settings on server side without any update to the device.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates traditional and improved views of a user experience for query formulation.

FIG. 3 illustrates another set of views 300 of a user experience for query formulations.

FIG. 4 illustrates a before-and-after view of a user experience in a SERP.

FIG. 5 illustrates a view of a user experience in SERP.

FIG. 6 illustrates a workflow diagram of a query formulation user experience.

FIG. 7 illustrates a workflow diagram of a SERP user experience.

FIG. 8 illustrates a method in accordance with the disclosed architecture.

FIG. 9 illustrates an alternative method in accordance with the disclosed architecture.

FIG. 10 illustrates yet another alternative method in accordance with the disclosed architecture.

FIG. 11 illustrates a block diagram of a computing system that executes device application and settings information search based on server signals in accordance with the disclosed architecture.

### DETAILED DESCRIPTION

Operating systems by Microsoft Corporation, such as Windows 8.1, introduce a Search Charm experience with a common entry point and interface to return results from both local sources and web sources (local results and web results). The query sent to the backend web search engine (to get relevant web results) introduced the capability of using backend-powered signals to improve relevance of the local results. Additionally, instrumentation is received for user search sessions which enabled the search engine (e.g., Bing) to learn to return relevant local results.

The disclosed architecture addresses the optimization of the user search experience by including relevant applications and settings that the user has installed locally on a device, using network-based backend-powered signals. There are many cases where the intent is definitively for an application, but using only signals coming from the device (usually just simple word matching) is not capable of solving that intent. A few examples show the cases handled by that solution:
simple misspellings
   {calcculator}→Calculator
   {wrodpad}→WordPad
complex misspellings (with high edit distance)
   {[aomt}→Paint
likely application intent without actual misspelling
   {pint}→Paint
synonyms
   {terminal}→Command Prompt
   {clipper}→Snipping Tool
complex queries
   {how to update windows}→Windows Update

However, handling a large variety of queries from users is never really possible without using backend signals. Traditionally, the results for applications and settings were surfaced (returned) only using the built-in indexer and search technology on the device. This had been limited by the inherent device inability to house extremely large amounts of data about possible terms that map to an application or setting, update the indexer or search technology over time, and quickly adapt to changes in settings or application ecosystem on the user device.

The disclosed architecture utilizes server-based signals (e.g., past engagement, application popularity, spell-correction, mined search patterns, machine learning models, etc.) to improve relevance of search results of the local applications and settings. This architecture works for any operating system (OS) and any device that has local settings or applications installed. This architecture also covers instances where server-signals are being used to improve queries on devices where settings are searched but no applications are installed or will not be installed.

The following techniques retrieve the most relevant application and settings given the user query. This can be accomplished by:
Mining past sessions of searches to retrieve patterns from unsuccessful sessions and understand eventually the user intent.
Using search engine techniques and infrastructure (e.g., speller, machine learning models, etc.) to obtain more possible candidates that are relevant for the query.
Solving the ranking problem of those candidates.
Automatically improving the relevance of the technology to return applications and settings on server side without any update to the device.

Some additional techniques to retrieve the most relevant applications and settings for user queries (in an offline manner such that the results can be stored in a lookup table) include:

a. Identify the intent of a query by comparing its click distribution (in query logs) to the click distributions of queries with known setting/app intent

b. Showing the query to human annotators/judges and having them suggest the best settings/apps or pick the best settings/apps from a machine-learning-filtered list of candidate settings/apps

c. Mine or otherwise identify patterns that express setting/app intent (e.g., “open <app>” or “help with <setting>”), and use those patterns to identify queries which are good for specific settings/apps.

The disclosed architecture improves several aspects of search:
query formulation (instant suggestions)
search performed on search engine results page (SERP) (once the user selects Enter with the query entered in the search box)

The disclosed architecture:
Uses a server-based approach to determine best applications and settings (e.g., using different techniques to build a common lookup table (LUT) used at the query formulation phase (to guarantee short latency) and deeper techniques such as speller and machine learning models to power the SERP (search engine results page) experience
Automatically learns from logs (gathering and mining logs enables utilization of the logs in the automatic learning process)
Employs adaptive learning for applications and settings (gathered logs are automatically processed to improve relevance of the results and spot the defects, and automatically improve and identify new applications and settings over time).
Uses search engine technology and infrastructure to rank applications and settings (search-engine components (e.g., speller) and search engine techniques (e.g., machine learning models) are employed to not only to retrieve relevant candidates but also to rank them).
Performs a personalized applications and settings search (User-specific ranking of applications and settings. Search is improved for custom applications on the user machine (e.g., a result {headtrax} can be returned for a misspelled query of {headtracks})).

With respect to identifying best results for a query, both query formulations and SERP sessions are instrumented and the associated logs are utilized as a feedback loop to improve results and detect bad queries, where the results may be imperfect. The algorithms operating offline utilize the logs.

Pipelines are developed that mine the logs to detect certain search patterns and use unsuccessful search sessions to understand what has eventually satisfied the user. For example, the final satisfaction click after original unsuccessful queries can be mined for applications and settings. This can be considered as constant feedback loop delivered by users that enable the constant improvement of the results (e.g., once enough data is obtained for the given query). Those techniques enable the capture of unobvious cases such as {terminal}→Command Prompt or {clipper}→Snipping Tool.

Both high quality mined data and human judgments can be employed to train a machine learning models to rank relevant applications and settings in ways similar to ranking the returned algorithms in the web search. The speller is utilized and the mining of misspellings that are only common for applications/settings scenarios, for example, {pint}→{paint}; {pint} is not a misspelling in a regular web search scenario.

With respect to returning results to the user, workflows are used, which differ for the experiences provides. Query formulation targets low latency and is a lookup table prepared offline (served from the backend), while the SERP experience may have higher latency and more complex logic.

With respect to a high-level overview of a query formulation scenario, where the user enters a partial query in the search box. After entering any letter, a request is sent to the server, and the server returns the most appropriate query suggestions (including likely applications and settings) by accessing the LUT that is prepared offline. The user might select a suggestion or perform a more detailed search on SERP. Additionally, the top auto-completions/auto-corrections of the partial query are utilized in the lookup as well. In this way, the LUT does not need to be populated with partial queries. If a user types “free ap”, then the auto-completion attempt can complete that into “free apps” and return “Store”.

With respect to a high-level overview of SERP scenario, the user enters a query that is sent to the search engine backend. The backend is triggered to find the most relevant information for that query (including applications and settings). Different techniques that can be used include a LUT (to speed up the most obvious cases), a speller (to get candidates for common misspellings), machine learning models (to get additional candidates and rank the candidates), and so on. The backend merges applications and settings data with regular web results and returns a common response. The results are displayed on the client.

The disclosed architecture supports constant and nearly immediate improvements since results are served from the backend over which full control is maintained.

The disclosed architecture exhibits technical effects rooted in computer technology to overcome problems specifically occurring in the realm of computer systems and networks. More specifically, the architecture enables improved user efficiency by way of device applications and settings information being searched and returned to the user in the search engine results page, or other document type. Additionally, the disclosed architecture enables increased user action performance by ranking the application(s) and setting(s) as potentially top ranked result(s) relative to the other search results returned. Thus, the top ranked results can be prominently displayed for more efficient and effective visual cues to the user, and hence, user interaction.

Reference is now made to the drawings, wherein like reference numerals are used to refer to like elements throughout. In the following description, for purposes of explanation, numerous specific details are set forth in order to provide a thorough understanding thereof. It may be evident, however, that the novel implementations can be practiced without these specific details. In other instances, well known structures and devices are shown in block diagram form in order to facilitate a description thereof. The intention is to cover all modifications, equivalents, and alternatives falling within the spirit and scope of the claimed subject matter.

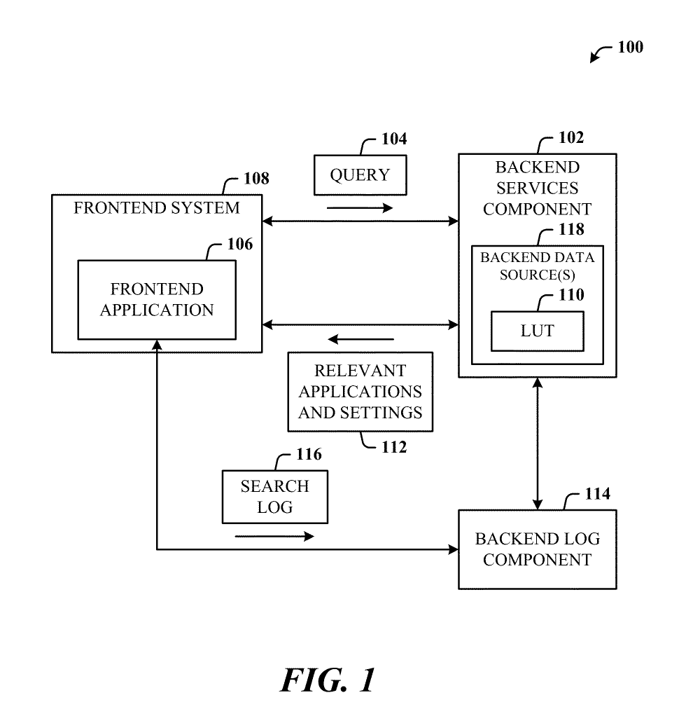

FIG. 1 illustrates a system 100 in accordance with the disclosed architecture. The system 100 can include a backend services component 102 (backend is intended to mean hardware/software that are not frontend; backend systems operate indirectly in support of a frontend system, and include non-frontend systems such as intermediate hardware/software systems) configured to receive a query 104 from a frontend application 106 (e.g., a browser, office application, etc.) of a frontend system 108 (frontend system is intended to mean client-side hardware/software with which the user directly interacts) as part of a user session, and enable access to a lookup table (LUT) 110 to find relevant applications and settings 112 of the frontend system 108. The backend services component 102 returns the relevant applications and settings 112 to the frontend application 106 for presentation as search results.

Alternatively, the system 100 can comprise the backend services component 102 configured to receive the query 104 from the frontend system 108 or the frontend application 106 of the frontend system 108, as part of the user session, the backend services component 102 configured to access backend data source(s) 118 to find the relevant applications and settings 112 of (for) the frontend system 108, and to return the relevant applications and settings 112 to the frontend application 106 for presentation as search results. The backend data source(s) 118 can include the LUT 110, a spell checker, and/or machine learning models, for example.

The system 100 can also comprise a backend log component 114 configured to receive a search log 116 of the user session from the frontend system 108, store the search log 116, and enable access to the search log 116 for log analysis and model training. The system 100 can also comprise at least one hardware processor configured to execute computer-executable instructions in a memory, the instructions executed to enable the backend services component 102 and the backend log component 114.

The backend services component 102 can be configured to access the data source, which data sources comprise is a lookup table used to identify obvious query cases, a spell checker used to identify common misspelling candidates, and machine learning models used to identify additional candidates and candidate rankings. The user sessions comprise query formulation sessions and full-query (SERP) sessions, both sessions of which are instrumented and saved as session logs, the session logs employed in an automated learning process.

The backend log component 114 can be configured to receive the search log 116 of the user session from the frontend system 108, store the search log 116, and enable access to the search log 116 for use in log analysis and model training.

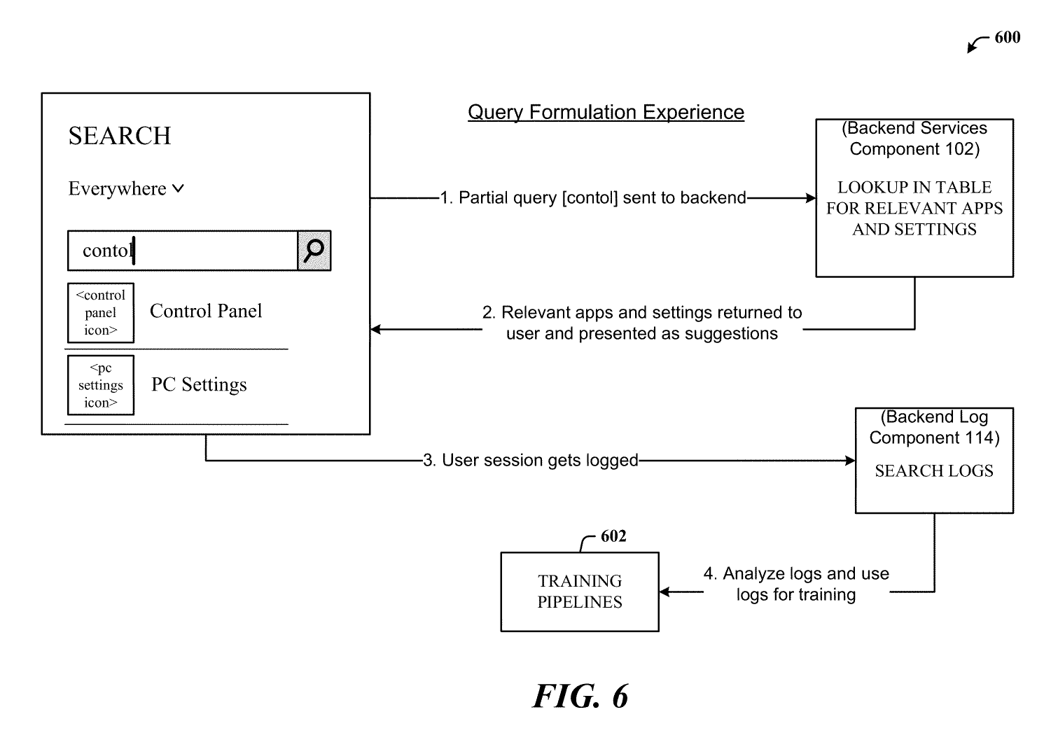

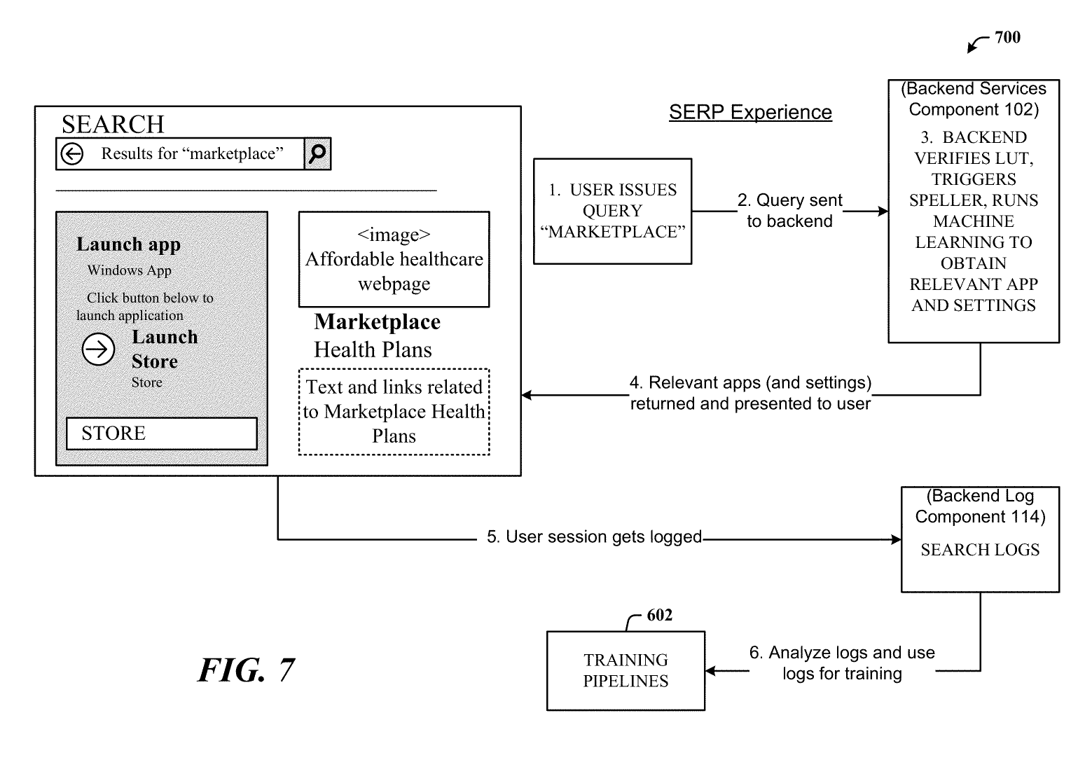

The system 100 can further comprise one or more training pipelines (of FIG. 6 and FIG. 7) configured to analyze the session logs to detect specific search patterns and unsuccessful search sessions and identify successful search sessions. The one or more training pipelines can be configured to identify a final user interaction after unsuccessful queries for the applications and application settings. The one or more training pipelines serve as feedback sources that identify and feedback a satisfied-user state based on the final user interaction to improve future results for a given query.

The backend services component 102 can be configured to process a partial query (one at a time as characters are received in the query box) to return query suggestions which comprise the relevant applications and settings 112. The backend services component 102 can be configured to process full query (all characters are entered into the query box before the user interacts (e.g., presses Enter, selects a Search icon, etc.) to cause execution of the full query) requests from the frontend system 108 to return relevant search results which comprise the relevant applications and settings 112.

The disclosed architecture can optionally include a privacy component that enables the user to opt in or opt out of exposing personal information such as queries and search logs. The privacy component enables the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

It is to be understood that in the disclosed architecture, certain components may be rearranged, combined, omitted, and additional components may be included. For example, the backend data source(s) 118 can be located external from the backend services component 102. In another example, the backend log component 114 can be made part of the backend services component 102. Still further, the backend services component 102, backend data source(s) 118 and backend log component 114 can be part of a web search engine framework.

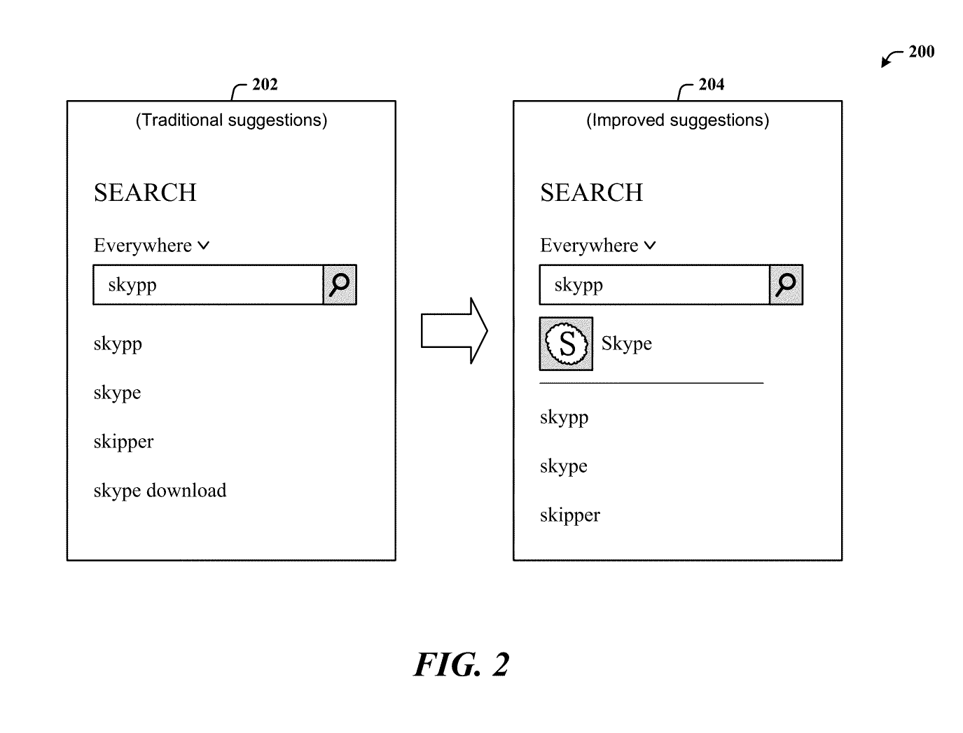

FIG. 2 illustrates traditional and improved views 200 of a user experience for query formulation. A traditional view 202 illustrates the presentation of suggested query formulations using a traditional search system. The example shows a user entering a query with intent to find a Skype™ application, but the user mistyped and added an additional letter ‘p’ by mistake at the end of the entry. The traditional search engine returns suggested formulations of “skypp”, “skype”, “skipper”, “skype download”, and so on, which are not useful to the user experience.

An improved view 204 illustrates that the disclosed architecture provides improved suggestions that show a top-ranked Skype application launcher for the client system. Thus, using web server-based signals as described herein, the query can still be handled correctly to return client-side applications and/or settings.

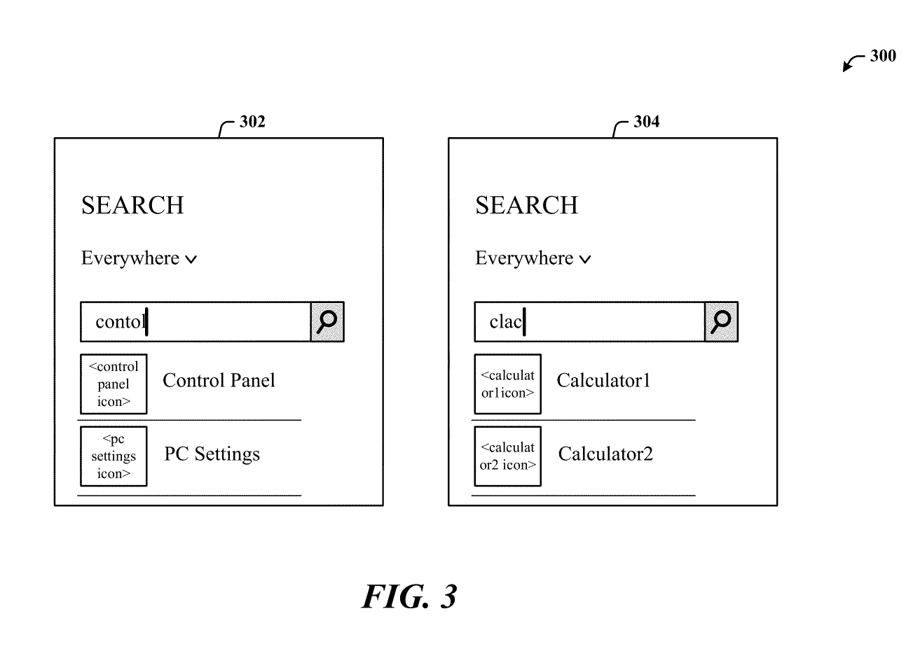

FIG. 3 illustrates another set of views 300 of a user experience for query formulation. In a first view 302 generated by employing the disclosed architecture, the query formulation experience using server-derived signals shows that partial query entry of the characters “control” results in the suggested results of client-side applications of Control Panel and PC Settings. In a second view 304, partial entry of the characters “clac” is interpreted as the user intent to interact with a calculator. Accordingly, the disclosed architecture operates to return a ranked set that includes a first calculator application (Calculator1) and a second calculator application (Calculator2). User interaction with either of these applications results in the launch of the selected calculator application on the client machine. In both views (302 and 304), the user intent is quite clear, but only by utilizing server-based signals can the query entry characters be handled correctly.

Other implementations addressed by the disclosed architecture cover a wider range of queries and misspellings. These implementations include, but are not limited to, the following:

a. Variations on queries where the user knows the setting/application, but not the exact keywords can include:
i. “word pad”→WordPad
ii. “app store”→Store
iii. “voice recorder”→Sound Recorder
iv. “dos prompt”→Command Prompt

b. Implicit queries—user has an intent, but does not know the right setting/application:
i. “open the internet”→Internet Explorer
ii. “get apps for windows”→Store
iii. “enlarge screen”→Magnifier
iv. “post its for desktop”→Sticky Notes

c. Action queries—user wants to accomplish a specific task:
i. “install a printer”→Device settings
ii. “launch skype”→Skype
iii. “listen to music”→Music
iv. “disable airplane mode”→Airplane Mode

d. Help queries—user is seeking help:
i. “how do I delete an app”→Uninstall apps to free up disk space
ii. “where are my documents”→Documents
iii. “my screen is too bright”→Change screen brightness
iv. “how do I shutdown”→Turn off your PC

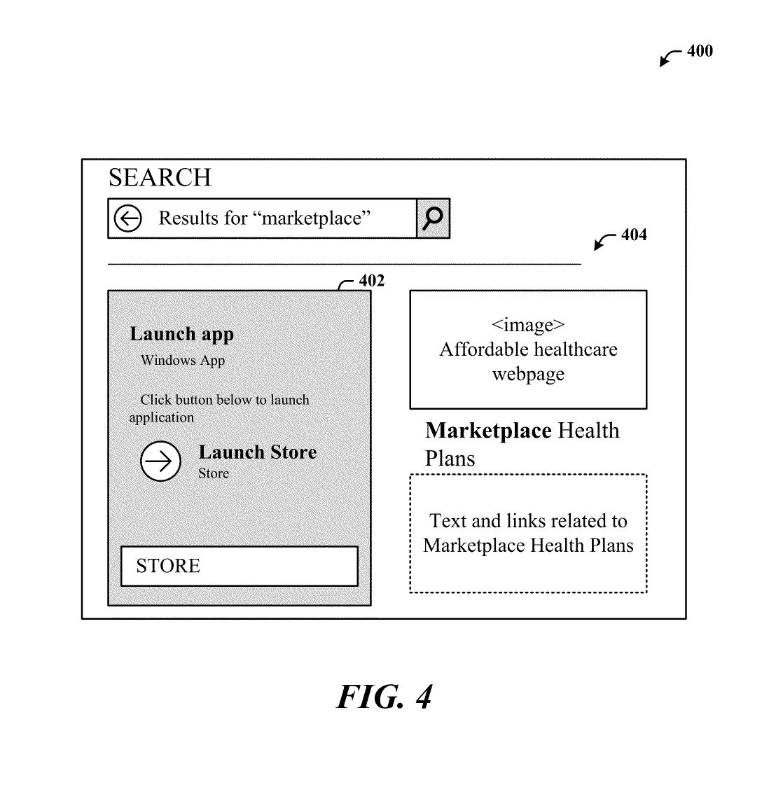

FIG. 4 illustrates a view 400 of a SERP user experience in a search engine results page (SERP). This example shows the user performing search on a SERP. When employing the disclosed architecture, the search term “marketplace”→captures the user intent and returns cases for applications and/or settings based on the server-side signals. Based on past user sessions for such queries, it can be derived and understood that the user entering the query for {marketplace} was not actually intending to engage or view web results, but rather was reformulating the query and going to the Store application.

A result interaction panel 402 for a local client-side result is top ranked and shown on the left side or in a predominant way in the results 404, while a lesser important result for web-based results of Marketplace Health Plans is presented on the right side (in a less prominent way) of the results 404.

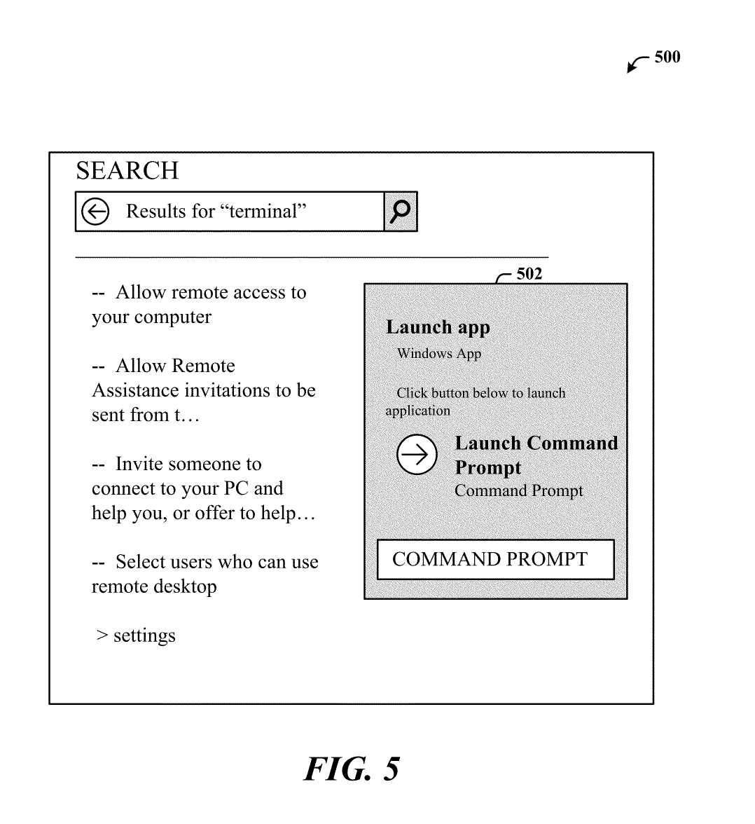

FIG. 5 illustrates a view 500 of a user experience in a search engine results page (SERP). This example shows the user performing search on SERP. The traditional search for “terminal” would indicate the inability to capture the application intent, and will return pure (only) web results that are unlikely relevant to the user intent.

With the new disclosed architecture, the search for “terminal” captures application intent and returns results for the client-side system. Based on past user sessions for such queries, it is known that the user entering the query for {terminal} was not actually seeking to engage the web results, but rather was reformulating the query and going to the Command Prompt. Accordingly, a result interaction panel 502 is presented that enables the user to engage and access the command prompt of the operating system. In this example, the local client-side result is shown on the right-side and additional client-side settings are shown on the left side.

FIG. 6 illustrates a workflow diagram 600 of a query formulation user experience. As the user enters a query of “control” in the frontend browser application of the frontend system 108, for example, the user-typed partial query is sent from the browser (frontend) application to the backend services component 102. The backend services component 102 then performs a lookup in a LUT for relevant applications (Apps) and settings. Additionally, the top ranked auto-completions/auto-corrections of the partial query can be utilized in the lookup of the LUT as well. In this way, the LUT does not need to be populated with partial queries. If a user types “free ap”, then the auto-completion attempt can complete that partial query into “free apps” and return “Store” for the Store application.

The backend services component 102 returns the relevant applications (apps) and settings to the browser (frontend application 106) for display to as suggestions. The browser then sends the user session to get logged in the backend log component 114 with other search logs. The backend logs can then be used for analysis and for training of one or more training pipelines 602.

FIG. 7 illustrates a workflow diagram 700 of a SERP user experience.

Initially, the user issues a query “marketplace” in the frontend application (e.g., browser). The browser sends the query to the backend services component 102. The backend services component 102 verifies the LUT, triggers the speller, and runs one or more machine learning models used to compute relevant applications. The backend services component 102 then returns the relevant applications to the browser, which are displayed in the SERP to the user on the client system. The user session then gets logged back to the backend log component 114 with other search logs. As before, the backend enables analysis of the logs and for training in the training pipelines 602.

As shown, there is the feedback loop (through instrumentation and session logs) used to improve the backend systems for more accurate client-side results for applications and/or settings. The feedback loop is used for both finding defects (for the cases being triggered) and discovering recall issues (through analyzing next user steps after an unsuccessful query).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

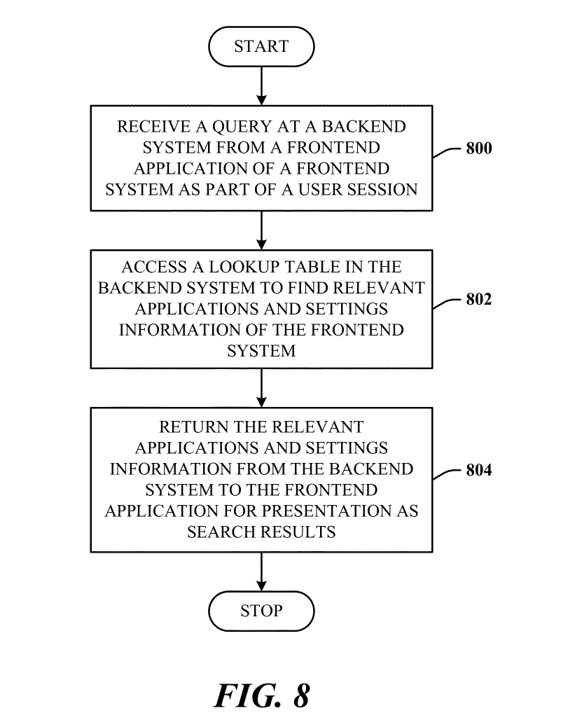

FIG. 8 illustrates a method in accordance with the disclosed architecture. At 800, a query is received at a backend system from a frontend application of a frontend system as part of a user session. At 802, a lookup table in the backend system is accessed to find relevant applications and settings information of the frontend system. At 804, the relevant applications and settings information is returned from the backend system to the frontend application for presentation as search results.

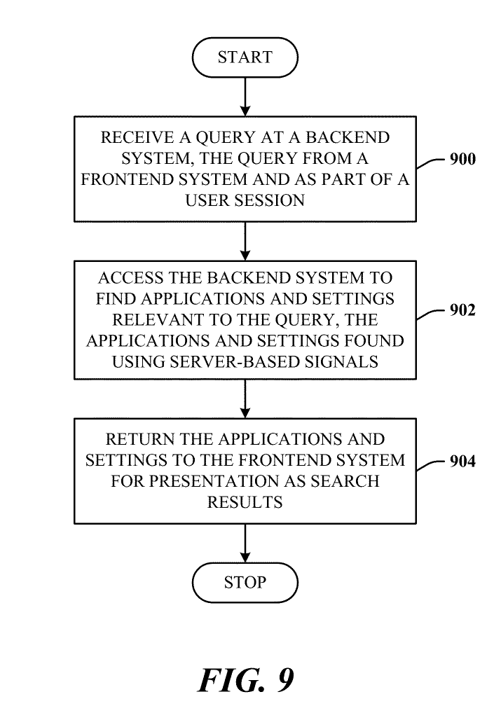

FIG. 9 illustrates an alternative method in accordance with the disclosed architecture. At 900, a query is received at a backend system, the query from a frontend system and as part of a user (search) session. At 902, the backend system is accessed to find applications and/or settings relevant to the query, the applications and/or settings found using server-based signals. At 904, the applications and/or settings are returned to the frontend system for presentation as search results with web search results or as client-side results only.

The method can further comprise deriving a server-based signal from mining past search sessions to retrieve patterns of unsuccessful sessions and derive user intent relevant to the query. The method can further comprise obtaining candidate applications and settings using a web search infrastructure.

The method can further comprise ranking the candidate applications and settings to generate a ranked set of candidates. The method can further comprise returning the relevant applications and settings without updating the frontend system according to the relevant applications and settings. The method can further comprise automatically identifying new applications and settings over time.

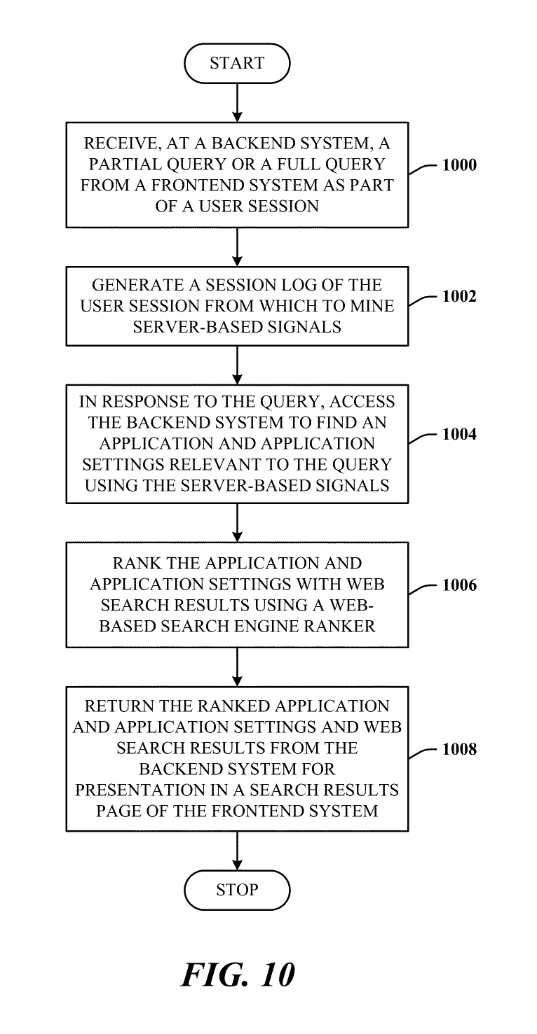

FIG. 10 illustrates yet another alternative method in accordance with the disclosed architecture. At 1000, receiving, at a backend system, a partial query or a full query from a frontend system as part of a user session. At 1002, a session log of the user session is generated from which to mine server-based signals. At 1004, in response to the query, the backend system is accessed to find an application and application settings relevant to the query using the server-based signals. At 1006, the application and application settings are ranked with web search results using a web-based search engine ranker. At 1008, the ranked application and application settings and web search results are ranked from the backend system for presentation in a search results page of the frontend system.

The method can further comprise obtaining server-based signals related to past user engagement, application popularity, mined search patterns, spell checking, and machine learning models. The method can further comprise generating and mining session logs from partial query formulation sessions and full query search sessions, to identify a final user-satisfaction interaction.

The method can further comprise obtaining the server-based signals from a server-based lookup table of commonly-used queries, from a spell checker for candidates of misspellings, and from machine learning models for candidates and results ranking. The method can further comprise performing customized ranking of the application and application settings specific to a frontend system of a user using the web-based search engine ranker.

As used in this application, the term “component” is intended to refer to a computer-related entity, either hardware, a combination of software and tangible hardware, software, or software in execution. For example, a component can be, but is not limited to, tangible components such as one or more microprocessors, chip memory, mass storage devices (e.g., optical drives, solid state drives, magnetic storage media drives, etc.), computers, and portable computing and computing-capable devices (e.g., cell phones, tablets, smart phones, etc.). Software components include processes running on a microprocessor, an object (a software entity that maintains state in variables and behavior using methods), an executable, a data structure (stored in a volatile or a non-volatile storage medium), a module (a part of a program), a thread of execution (the smallest sequence of instructions that can be managed independently), and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

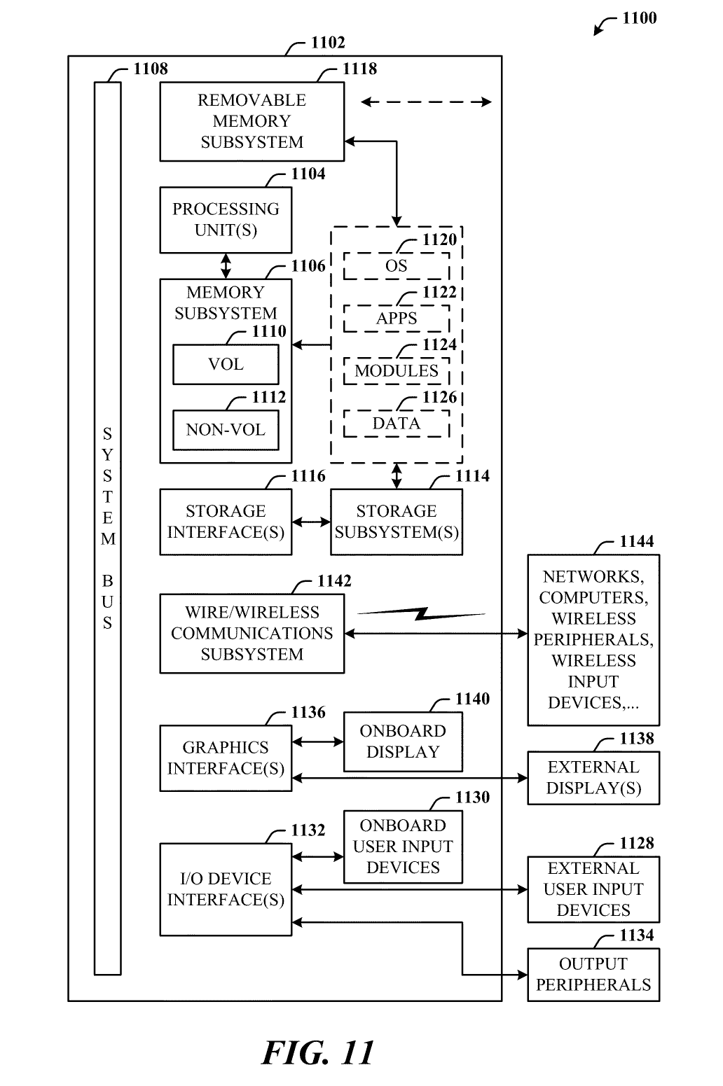

Referring now to FIG. 11, there is illustrated a block diagram of a computing system 1100 that executes device application and settings information search based on server signals in accordance with the disclosed architecture. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc., where analog, digital, and/or mixed signals and other functionality can be implemented in a substrate.

In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel implementation also can be realized in combination with other program modules and/or as a combination of hardware and software.

The computing system 1100 for implementing various aspects includes the computer 1102 having microprocessing unit(s) 1104 (also referred to as microprocessor(s) and processor(s)), a computer-readable storage medium (where the medium is any physical device or material on which data can be electronically and/or optically stored and retrieved) such as a system memory 1106 (computer readable storage medium/media also include magnetic disks, optical disks, solid state drives, external memory systems, and flash memory drives), and a system bus 1108. The microprocessing unit(s) 1104 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1102 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1106 can include computer-readable storage (physical storage) medium such as a volatile (VOL) memory 1110 (e.g., random access memory (RAM)) and a non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the microprocessing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components and circuits. The storage subsystem(s) 1114 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include items and components of the system 100 of FIG. 1, items, flow, and component views of FIGS. 2-5, items, flow, and components workflows of FIGS. 6-7, and the method represented by the flowchart of FIGS. 8-10, for example.

Generally, programs include routines, methods, data structures, other software components, etc., that perform particular tasks, functions, or implement particular abstract data types. All or portions of the operating system 1120, applications 1122, modules 1124, and/or data 1126 can also be cached in memory such as the volatile memory 1110 and/or non-volatile memory, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1102, and include volatile and non-volatile internal and/or external media that is removable and/or non-removable. For the computer 1102, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1102, programs, and data using external user input devices 1128 such as a keyboard and a mouse, as well as by voice commands facilitated by speech recognition. Other external user input devices 1128 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 1102, programs, and data using onboard user input devices 1130 such a touchpad, microphone, keyboard, etc., where the computer 1102 is a portable computer, for example.

These and other input devices are connected to the microprocessing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

The architecture can be implemented as a system, that comprises means for receiving a query at a backend system from a frontend application of a frontend system as part of a user session; means for accessing a lookup table in the backend system to find relevant applications and settings information of the frontend system; and, means for returning the relevant applications and settings information from the backend system to the frontend application for presentation as search results.

The architecture can be implemented as another system, that comprises means for receiving a query at a backend system, the query from a frontend system and as part of a user session; means for accessing the backend system to find applications and settings relevant to the query, the applications and settings found using server-based signals; and, means for returning the applications and settings to the frontend system for presentation as search results.

The architecture can be implemented as yet another system, that comprises means for receiving, at a backend system, a partial query or a full query from a frontend system as part of a user session; means for generating a session log of the user session from which to mine server-based signals; means for, in response to the query, accessing the backend system to find an application and application settings relevant to the query using the server-based signals; means for ranking the application and application settings with web search results using a web-based search engine ranker; and, means for returning the ranked application and application settings and web search results from the backend system for presentation in a search results page of the frontend system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a hardware processor and a memory device, the hardware processor configured to execute computer-executable instructions in the memory device, the instructions executed to enable one or more components, comprising;
a backend services component configured to receive a query from a frontend application of a frontend system as part of a user session, to access one or more backend data sources to find relevant applications and settings of the frontend system, and to return the relevant applications and settings to the frontend application for presentation as search results.

2. The system of claim 1, wherein the backend services component is configured to access the one or more backend data sources, which data sources comprise a lookup table used to identify obvious query cases, a spell checker used to identify common misspelling candidates, and machine learning models used to identify additional candidates and candidate rankings.

3. The system of claim 1, wherein the user sessions comprise query formulation sessions and full-query sessions, both of which are instrumented and saved as session logs, the session logs employed in an automated learning process.

4. The system of claim 1, further comprising a backend log component configured to receive a search log of the user session from the frontend system, store the search log, and enable access to the search log for use in log analysis and model training.

5. The system of claim 1, further comprising training pipelines configured to analyze the session logs to detect specific search patterns and unsuccessful search sessions and identify successful search sessions.

6. The system of claim 5, wherein the training pipelines are configured to identify a final user interaction after unsuccessful queries for the applications and application settings.

7. The system of claim 5, wherein the training pipelines serve as feedback sources that identify and feedback a satisfied-user state based on the final user interaction to improve future results for a given query.

8. The system of claim 1, wherein the backend services component is configured to a process partial query to return query suggestions which comprise the relevant applications and settings.

9. The system of claim 1, wherein the backend services component is configured to process full query requests from the frontend system to return relevant search results which comprise the relevant applications and settings.

10. A method, comprising acts of:
receiving a query at a backend system, the query from a frontend system and as part of a user session;
accessing the backend system to find applications and settings relevant to the query, the applications and settings found using server-based signals; and
returning the applications and settings to the frontend system for presentation as search results.

11. The method of claim 10, further comprising deriving a server-based signal from mining past search sessions to retrieve patterns of unsuccessful sessions and derive user intent relevant to the query.

12. The method of claim 10, further comprising obtaining candidate applications and settings using a web search infrastructure.

13. The method of claim 12, further comprising ranking the candidate applications and settings to generate a ranked set of candidates.

14. The method of claim 10, further comprising returning the relevant applications and settings without updating the frontend system according to the relevant applications and settings.

15. The method of claim 10, further comprising automatically identifying new applications and settings over time.

16. A method, comprising acts of:
receiving, at a backend system, a partial query or a full query from a frontend system as part of a user session;
generating a session log of the user session from which to mine server-based signals;
in response to the query, accessing the backend system to find an application and application settings relevant to the query using the server-based signals;
ranking the application and application settings with web search results using a web-based search engine ranker; and
returning the ranked application and application settings and web search results from the backend system for presentation in a search results page of the frontend system.

17. The method of claim 16, further comprising obtaining server-based signals related to past user engagement, application popularity, mined search patterns, spell checking, and machine learning models.

18. The method of claim 16, further comprising generating and mining session logs from partial query formulation sessions and full query search sessions, to identify a final user-satisfaction interaction.

19. The method of claim 16, further comprising obtaining the server-based signals from a server-based lookup table of commonly-used queries, from a spell checker for candidates of misspellings, and from machine learning models for candidates and results ranking.

20. The method of claim 16, further comprising performing customized ranking of the application and application settings specific to a frontend system of a user using the web-based search engine ranker.
